(19) United States
(12) Patent Application Publication
(10) Pub. No.: US 2026/0208523 A1
(43) Pub. Date: Jul. 23, 2026

(54) WRITING INSTRUMENT

(71) Applicant: KABUSHIKI KAISHA PILOT CORPORATION (also trading as PILOT CORPORATION), Tokyo-to (JP)

(72) Inventors: Takashi IWAHARA, Tokyo-to (JP); Yoshimasa SUGAHARA, Tokyo-to (JP); Yu SHIMIZU, Tokyo-to (JP)

(21) Appl. No.: 19/143,206

(22) PCT Filed: Dec. 19, 2023
(86) PCT No.: PCT/JP2023/045443

§ 371 Date: Jun. 25, 2025

(30) Foreign Application Priority Data
Dec. 27, 2022 (JP) 2022-210740

(51) Int. Cl. B43K 5/17; B43K 24/08

(52) U.S. Cl. CPC B43K 5/17; B43K 24/08

(57) ABSTRACT

A writing instrument (10) includes: a barrel (20) having an opening (22a); a writing member (12) having a pen tip (13); an advancing and retracting mechanism (40) that advances and retracts the pen tip (13) from the opening (22a); and a sealing mechanism (70) that seals a housing space (S) of the pen tip (13) in a retracted state of the pen tip (13), the sealing mechanism (70) having a lid member (72) capable of coming into contact with a contact surface (22b) surrounding the opening (22a) to close the opening (22a), and a negative pressure suppression mechanism (80) that suppresses a pressure in the housing space (S) from becoming a negative pressure.

### TECHNICAL FIELD

The present invention relates to a writing instrument.

### BACKGROUND ART

Conventionally, there is known a writing instrument including a barrel, a writing member having a pen tip portion, and an advancing and retracting mechanism that advances and retracts the pen tip portion from the barrel. In addition, as such a writing instrument, there is also known a writing instrument including a sealing mechanism that seals a housing space of a pen tip to prevent ink from drying at the pen tip in a retracted state of the pen tip.

JP 2007-112032 A discloses a writing instrument including a barrel, a writing body housed inside the barrel, a lid disposed in front of the barrel, and a spring that biases the lid in a closing direction. In this writing instrument, when the writing body moves forward, the lid is pressed against a distal end of the writing body to open. In addition, when the writing body moves rearward in this state, the writing body is housed inside the barrel, and the lid is closed by a spring force of the spring to close the barrel. Thus, it is possible to prevent the ink from drying in the writing body while the writing body is housed in the barrel.

In the writing instrument including the sealing mechanism of the related art, the lid is closed with rearward movement of the writing body, and then the writing body further moves rearward to be housed in the barrel. At this time, when the writing body moves rearward after the lid body is closed, a negative pressure may be generated inside a housing space of the writing body. In this case, there is a possibility that the ink stored inside the writing body leaks into the housing space through the pen tip of the writing body.

### SUMMARY OF THE INVENTION

The present invention has been made in consideration of such a point, and an object thereof is to suppress ink in a writing body from leaking into a housing space of the writing body.

A writing instrument according to the present invention is
[1] a writing instrument including: a barrel having an opening; a writing member having a pen tip; an advancing and retracting mechanism that advances and retracts the pen tip from the opening; and a sealing mechanism that seals a housing space of the pen tip in a retracted state of the pen tip, wherein
the sealing mechanism has
a lid member capable of coming into contact with a contact surface surrounding the opening to close the opening, and
a negative pressure suppression mechanism that suppresses a pressure in the housing space from becoming a negative pressure.

A writing instrument according to the present invention is
[2] the writing instrument according to [1], wherein the negative pressure suppression mechanism has a closing delay mechanism that delays a timing at which the lid member closes the opening.

A writing instrument according to the present invention is
[3] the writing instrument according to [2], wherein
the lid member has a facing surface facing the contact surface, and
the closing delay mechanism has an elastically deformable portion provided on the contact surface or the facing surface.

A writing instrument according to the present invention is
[4] the writing instrument according to [3], wherein the elastically deformable portion is a protrusion protruding from the contact surface or the facing surface.

A writing instrument according to the present invention is
[5] the writing instrument according to [4], wherein the protrusion at least partially surrounds the opening.

A writing instrument according to the present invention is
[5] the writing instrument according to [4] or [5], wherein a height of the protrusion along a direction perpendicular to the contact surface or the facing surface decreases as a distance from a rotational axis of the lid member increases.

A writing instrument according to the present invention is
[7] the writing instrument according to any one of [1] to [6], wherein a rotational axis of the lid member is located opposite to the housing space with respect to an extended plane of the contact surface.

According to the present invention, it is possible to suppress the ink in the writing body from leaking into the housing space of the writing body.

### BRIEF DESCRIPTION OF DRAWINGS

FIG. 1 is a view for describing an embodiment of the present invention, and is a longitudinal sectional view illustrating an example of a writing instrument in a retracted state.

FIG. 2 is a longitudinal sectional view illustrating the writing instrument of FIG. 1 in a protruding state.

FIG. 3 is an enlarged longitudinal sectional view illustrating a front part of the writing instrument in FIG. 1.

FIG. 4 is a view illustrating an example of a negative pressure suppression mechanism of the writing instrument when viewed from the front.

FIG. 5 is a longitudinal sectional view illustrating an example of the negative pressure suppression mechanism.

FIG. 6 is an enlarged view of a part denoted by VI in FIG. 5.

FIG. 7 is an enlarged view of a part denoted by VII in FIG. 6.

FIG. 8 is a longitudinal sectional view illustrating a part of the negative pressure suppression mechanism.

FIG. 9 is an enlarged view of a part denoted by IX in FIG. 8.

FIG. 10 is a view for describing an operation of the negative pressure suppression mechanism.

FIG. 11 is a view for describing the operation of the negative pressure suppression mechanism.

FIG. 12 is an enlarged view of a part denoted by XII in FIG. 11.

### BEST MODE FOR CARRYING OUT THE INVENTION

Hereinafter, an embodiment of the present invention will be described with reference to the drawings. Note that, in the drawings attached to the present specification, scales, vertical and horizontal dimensional ratios, and the like are appropriately changed and exaggerated from the actual ones for convenience of illustration and ease of understanding.

In addition, terms such as “parallel”, “orthogonal”, “same”, and the like, values of length and angle, and the like, which specify shapes and geometric conditions and degrees thereof, used in the present specification are interpreted including a range in which similar functions can be expected without being bound by a strict meaning.

In the present specification, a direction in which a central axis A of a writing instrument 10 extends (a longitudinal direction) is defined as an axial direction da, a direction orthogonal to the axial direction da is defined as a radial direction, and a direction along a circumference around the central axis A is defined as a circumferential direction. Along the axial direction da, a pen tip side is defined as front or forward, and a side opposite to the pen tip is defined as rear or rearward. In addition, along the radial direction, a side approaching the central axis A is defined as an inside or inward, and a side away from the central axis A is defined as an outside or outward.

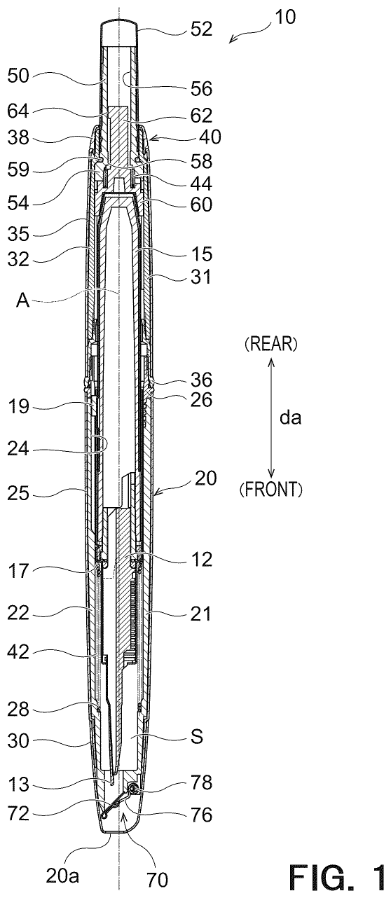

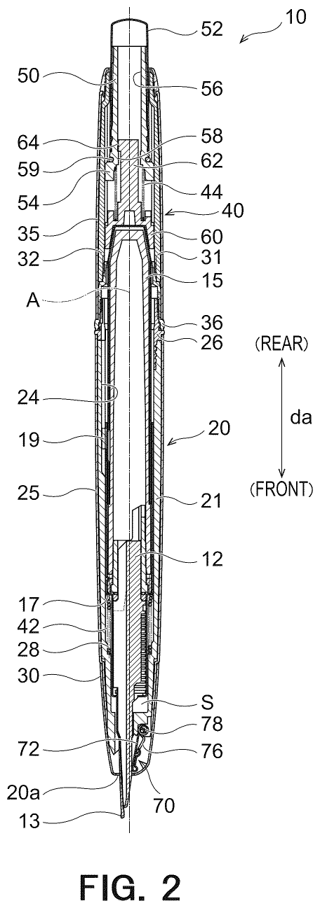

FIG. 1 is a view for describing the embodiment of the present invention, and is a longitudinal sectional view illustrating an example of the writing instrument 10 in a retracted state, and FIG. 2 is a longitudinal sectional view illustrating the writing instrument 10 in a protruding state.

The writing instrument 10 of the present embodiment includes a writing member 12, a barrel 20, an advancing and retracting mechanism 40, and a sealing mechanism 70. The writing instrument 10 extends along the central axis A. The writing member 12 is a member that forms a handwriting on a writing surface such as a paper surface. The writing member 12 is housed in the barrel 20. Examples of the writing member 12 include members used for a ballpoint pen, a fountain pen, and a marker. In the present embodiment, an example in which the writing instrument 10 is a fountain pen will be described. The writing member 12 of the present embodiment includes a pen tip 13 provided at a front end portion, a storage tube 15 storing ink, a first receiving portion 17, and a protrusion 19. The storage tube 15 may be, for example, a cartridge type or a converter. The first receiving portion 17 is a surface facing forward in a step portion formed on an outer surface of the writing member 12, and receives a spring force of a first resilient member 42 described later. The protrusion 19 protrudes radially outward from the main body of the writing member 12.

The advancing and retracting mechanism 40 is a mechanism for alternately switching the writing instrument 10 between a protruding state in which the pen tip 13 protrudes from a front end opening 20a of the barrel 20 and a retracted state in which the pen tip 13 is retracted from the front end opening 20a.

The barrel 20 includes a front barrel 21, a distal end member 30 disposed in front of the front barrel 21, and a rear barrel 31 disposed at the rear of the front barrel 21. A central axis of the barrel 20 coincides with the central axis A of the writing instrument 10. The front end opening 20a through which the pen tip 13 can pass is provided at a front end of the barrel 20. In the present embodiment, the front end opening 20a is formed at a front end of the distal end member 30.

The front barrel 21 is a member having a substantially tubular shape, and is intended to be gripped by fingers when a user performs writing with the writing instrument 10. The front barrel 21 of the present embodiment includes an inner barrel 22, an outer barrel 25 disposed radially outward of the inner barrel 22, and a first connecting member 26.

The inner barrel 22 is a member that houses the front part of the writing member 12 and defines a housing space S of the pen tip 13. The inner barrel 22 is a member having a substantially tubular shape having a central axis coinciding with the central axis A. In the present embodiment, the inner barrel 22 houses the entire pen tip 13 in the retracted state. A groove 24 to be engaged with the protrusion 19 of the writing member 12 is formed on an inner surface of the inner barrel 22. The groove 24 is a groove extending in the axial direction da, and the writing member 12 is supported so as to be movable in the axial direction da and non-rotatable in the circumferential direction with respect to the barrel 20 when the protrusion 19 of the writing member 12 is located in the groove 24. The inner barrel 22 is made of, for example, a resin material such as acrylonitrile-styrene (AS) copolymer resin, acrylonitrile-butadiene-styrene (ABS) copolymer resin, polycarbonate (PC), polypropylene (PP), polyethylene (PE), or elastomer, a rubber material such as nitrile butadiene rubber (NBR), or the like. Note that the inner barrel 22 may be configured using a single member or a plurality of members.

An opening 22a through which the pen tip 13 can pass is formed at a distal end portion of the inner barrel 22. A contact surface 22b is formed around the opening 22a. The contact surface 22b is a surface with which a lid member 72 described later comes into contact in the retracted state. A mode of contact between the contact surface 22b and the lid member 72 will be described later.

The outer barrel 25 is a member that is visually recognized by the user, the member being grasped by the fingers when the user performs writing with the writing instrument 10. Therefore, the outer barrel 25 is made of an appropriate material in consideration of designability and ease of holding for the user. For example, the outer barrel 25 may be made of resin, elastomer, metal, wood, or the like. The first connecting member 26 is a member constituting a connecting portion with the rear barrel 31. The first connecting member 26 is fixed to a rear end portion of at least one of the inner barrel 22 and the outer barrel 25. For example, the first connecting member 26 may be fixed to the rear end portion of at least one of the inner barrel 22 and the outer barrel 25 by adhesion or insert molding. The first connecting member 26 is made of, for example, resin, metal, or the like. Note that the present invention is not limited to the illustrated example, and the outer barrel 25 and the first connecting member 26 may be omitted. For example, the entire front barrel 21 may be integrally formed.

The distal end member 30 is a member that forms a distal end part of the barrel 20. The distal end member 30 has a function of protecting a front end portion of the front barrel 21, the lid member 72, and a resilient member 76. The distal end member 30 has a substantially truncated cone shape, and an outer diameter thereof decreases toward the front. The front end opening 20a through which the pen tip 13 protrudes and is retracted is formed at a front end of the distal end member 30. When a rear end portion of the distal end member 30 is attached to the front end portion of the front barrel 21, the distal end member 30 is connected to the front barrel 21. The distal end member 30 is connected to the front barrel 21 by, for example, press-fitting, adhesion, or screwing of a screw portion.

The rear barrel 31 is a member having a substantially tubular shape and disposed at the rear of the front barrel 21. The rear barrel 31 includes an inner barrel 32, an outer barrel 35 disposed radially outward of the inner barrel 32, a second connecting member 36, and a head cap 38.

The inner barrel 32 is a member that houses a rear part of the writing member 12. The inner barrel 32 is a member having a substantially tubular shape. The inner barrel 32 is made of, for example, resin, metal, wood, or the like. A plurality of serrated cam teeth protruding forward and a groove formed between the cam teeth and extending in the axial direction da are formed on an inner peripheral surface of the inner barrel 32.

The outer barrel 35 is a member visually recognized by the user. Therefore, the outer barrel 35 is made of an appropriate material in consideration of designability and the like. For example, the outer barrel 35 may be made of resin, elastomer, metal, wood, or the like. The second connecting member 36 is a member constituting the connecting portion with the front barrel 21. The second connecting member 36 is fixed to a front end portion of at least one of the inner barrel 32 and the outer barrel 35. For example, the second connecting member 36 may be fixed to the front end portion of at least one of the inner barrel 32 and the outer barrel 35 by adhesion or insert molding. The second connecting member 36 is made of, for example, resin, metal, or the like. Note that the present invention is not limited to the illustrated example, and the inner barrel 32 and the outer barrel 35 may be configured using a single member. The inner barrel 32, the outer barrel 35, and the second connecting member 36 may be configured using a single member. That is, the entire rear barrel 31 may be integrally formed.

The advancing and retracting mechanism 40 is a mechanism for alternately switching the writing instrument 10 between the protruding state and the retracted state. The advancing and retracting mechanism 40 of the present embodiment includes a push member 50, a rotary cam member 60, the first resilient member 42, and a second resilient member 44.

The first resilient member 42 is, for example, a coil spring. The first resilient member 42 is disposed in a compressed state between the first receiving portion 17 of the writing member 12 and a second receiving portion 28 of the barrel 20 (the front barrel 21). The second receiving portion 28 is a stepped portion provided on an inner peripheral surface of the barrel 20 (the front barrel 21) and includes a surface facing rearward. In the present embodiment, the first receiving portion 17 receives a spring force from the first resilient member 42. Thus, the first resilient member 42 constantly biases the writing member 12 rearward of the barrel 20. Note that the first resilient member 42 constitutes a part of the advancing and retracting mechanism 40 and constitutes a part of the sealing mechanism 70 as described later.

The push member 50 is intended to be operated by the user. The push member 50 includes an operation portion 52 and a large-diameter portion 54 located in front of the operation portion 52. The operation portion 52 is a part pressed by the user's finger or the like. The operation portion 52 protrudes rearward from a rear end of the barrel 20 (the rear barrel 31). In the retracted state and the protruding state, a rear end of the operation portion 52 protrudes rearward from the rear end of the barrel 20. The large-diameter portion 54 has a radial dimension larger than a radial dimension of the operation portion 52. An inner diameter of a rear end portion of the barrel 20 has a size that allows passage of the operation portion 52 but does not allow passage of the large-diameter portion 54. Therefore, the push member 50 does not come out rearward from the rear end portion of the barrel 20.

A cam tooth protruding forward are formed at a front end of the large-diameter portion 54. In addition, on an outer peripheral surface of the large-diameter portion 54, a protrusion which engages with the groove formed on the inner peripheral surface of the barrel 20 (the rear barrel 31) is formed. The push member 50 is disposed to be movable in the axial direction da and not to be rotatable in the circumferential direction in a state in which the protrusion engages with the groove of the barrel 20.

A hole 56 extending in the axial direction da is formed inside the push member 50. In the present embodiment, the hole 56 is open at a front end of the push member 50 and closed at a rear end of the push member 50. An inward protrusion 58 protruding radially inward is formed on an inner surface of the hole 56.

An O-ring 59 is disposed on an outer peripheral surface of the push member 50. The O-ring 59 is disposed in a groove formed to annularly extend in the circumferential direction on the outer peripheral surface of the push member 50. In the example illustrated in FIG. 1, the O-ring 59 is disposed between the operation portion 52 and the large-diameter portion 54 of the push member 50. The O-ring 59 has a function of sealing between the inner peripheral surface of the barrel 20 (the rear barrel 31) and the outer peripheral surface of the push member 50 in the retracted state illustrated in FIG. 1. The O-ring 59 is made of, for example, an elastic material such as rubber.

The rotary cam member 60 has, on its outer surface, a plurality of ridges that extend in the axial direction da and engage with the groove of barrel 20. A cam surface inclined with respect to the axial direction da and the circumferential direction is formed at rear ends of the ridges. The cam surface engages with the cam tooth of the push member 50. The rotary cam member 60 has a rear protrusion 62 that protrudes rearward along the axial direction da. An engaging portion 64 is provided at a rear end of the rear protrusion 62. The engaging portion 64 is a protrusion protruding radially outward from the rear protrusion 62. The engaging portion 64 engages with the inward protrusion 58 of the push member 50 to restrict the movement of the push member 50 and the rotary cam member 60 in the axial direction da.

The second resilient member 44 is disposed between the push member 50 and the rotary cam member 60. The second resilient member 44 is, for example, a coil spring. The second resilient member 44 is disposed in the barrel 20 at the rear of the writing member 12. Specifically, the second resilient member 44 is disposed in a compressed state between the push member 50 and the rotary cam member 60. Therefore, the second resilient member 44 constantly biases the push member 50 rearward of the rotary cam member 60. Thus, although the push member 50 moves rearward of the rotary cam member 60, the engaging portion 64 of the rotary cam member 60 engages with the inward protrusion 58 of the push member 50, so that the push member 50 is prevented from further moving rearward of the rotary cam member 60. The push member 50 is biased rearward by the second resilient member 44 in a state in which the engaging portion 64 of the rotary cam member 60 engages with the inward protrusion 58 of the push member 50, so that rattling of the push member 50 is suppressed.

Since specific structures and operations of the groove of the barrel 20, the cam tooth and the protrusion of the push member 50, and the ridges and the cam surface of the rotary cam member 60 are known, detailed description thereof will be omitted. As an example, a structure of a mechanism disclosed in JP 2013-006281 A can be used as these specific structures.

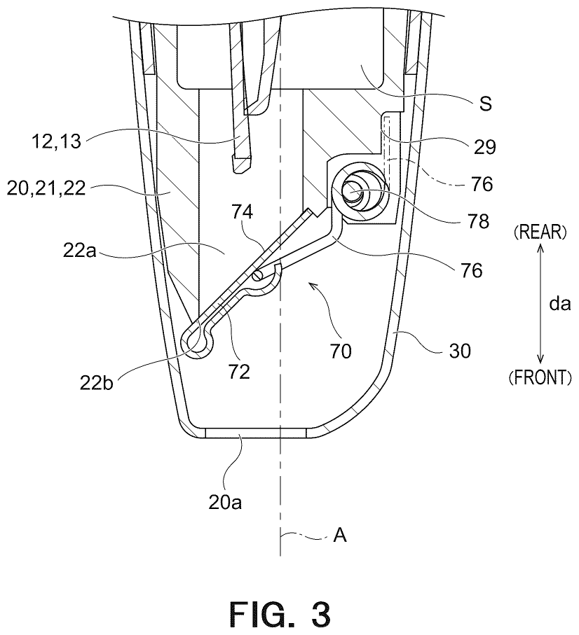

The writing instrument 10 of the present embodiment includes the sealing mechanism 70 that seals the housing space S of the pen tip 13. Hereinafter, the sealing mechanism 70 will be described mainly with reference to FIG. 3. FIG. 3 is an enlarged longitudinal sectional view illustrating a front part of the writing instrument 10. The sealing mechanism 70 of the present embodiment is a mechanism that seals a front end of the housing space S. The sealing mechanism 70 includes the contact surface 22b of the barrel 20 (the inner barrel 22), the lid member 72, the resilient member 76, and a pin 78.

The inner barrel 22 has the opening 22a through which the pen tip 13 can pass and the contact surface 22b surrounding the opening 22a. The lid member 72 is attached to the inner barrel 22. The resilient member 76 is a member that biases the lid member 72 toward the contact surface 22b by the spring force. The resilient member 76 is, for example, a torsion spring. The resilient member 76 has one end being attached to the lid member 72 and the other end being disposed in a recess 29 provided at a front end part of the inner barrel 22. The pin 78 is disposed to extend in the direction orthogonal to the axial direction da. In the example illustrated in FIG. 3, the pin 78 is inserted into a through hole provided at the front end part of the inner barrel 22. Further, the pin 78 is inserted into an annular portion provided at a proximal end portion of the lid member 72 and a loop part of the resilient member 76. Thus, the lid member 72 can rotate around the pin 78 to one side and the other side to come into contact with the contact surface 22b or to be separate from the contact surface 22b. That is, the pin 78 also serves as the rotational axis of the lid member 72. Note that a gap serving as a clearance may be formed between an annular portion provided at a proximal end portion of the lid member 72 and an outer peripheral surface of the pin 78. Even in this case, the pin 78 is substantially the rotational axis of the lid member 72.

The lid member 72 closes a front end of the inner barrel 22 in the retracted state to seal the housing space S, and allows the pen tip 13 to protrude in the protruding state. The lid member 72 has a facing surface 74 facing the contact surface 22b in a state in which the lid member 72 closes the opening 22a. The lid member 72 is biased by the resilient member 76 in a direction of sealing the housing space S of the pen tip 13. In the present embodiment, in the retracted state, the facing surface 74 of the lid member 72 comes into contact with the contact surface 22b of the inner barrel 22 by the spring force of the resilient member 76 to close the opening 22a. Thus, the housing space S of the pen tip 13 is sealed (see FIGS. 1 and 3). In this case, drying of the ink at the pen tip 13 is suppressed. At the time of transition from the retracted state to the protruding state, when the pen tip 13 moving forward pushes the lid member 72 forward so that the lid member 72 is opened, and the pen tip 13 protrudes forward through the opening 22a and the front end opening 20a (see FIG. 2). In this protruding state, writing by the writing instrument 10 becomes possible.

In a writing instrument including a sealing mechanism of the related art, a lid member is closed with rearward movement of a writing member, and then the writing member further moves rearward to be housed in a barrel. At this time, when the writing member moves rearward after the lid member is closed, a negative pressure may be generated inside a housing space of the writing member. In this case, ink housed in the writing member may leak into the housing space through a pen tip.

In order to solve such a problem, the sealing mechanism 70 of the present embodiment includes a negative pressure suppression mechanism 80 that suppresses the pressure of the housing space S from becoming a negative pressure. The negative pressure herein means a pressure lower than the pressure of the atmosphere, so-called atmospheric pressure, in an environment where the writing instrument 10 is placed. In the writing instrument 10 of the present embodiment in the retracted state, it is unnecessary for the pressure in the housing space S to be completely the same as the atmospheric pressure. In the present embodiment, it is allowed that the pressure in the housing space S becomes a negative pressure to such an extent that the possibility that the ink leaks into the housing space S through the pen tip 13 is sufficiently reduced. That is, suppressing the pressure in the housing space S from becoming the negative pressure includes not only making the pressure in the housing space S be the same pressure as the atmospheric pressure, but also making the pressure in the housing space S be the negative pressure to such an extent that the possibility that the ink leaks into the housing space S through the pen tip 13 is sufficiently reduced.

The negative pressure suppression mechanism 80 of the present embodiment includes a closing delay mechanism 82 that delays a timing at which the lid member 72 closes the opening 22a of the barrel 20 (the inner barrel 22). In the negative pressure suppression mechanism 80 of the present embodiment, the timing at which the lid member 72 closes the opening 22a is delayed by the closing delay mechanism 82 to reduce the amount of rearward movement of the writing member 12 after the opening 22a is closed, thereby suppressing the pressure of the housing space S from becoming the The closing delay mechanism 82 of the present embodiment includes an elastically deformable portion 84 provided on the contact surface 22b or the facing surface 74. In a case where the contact surface 22b of the barrel 20 (the inner barrel 22) has the elastically deformable portion 84, the elastically deformable portion 84 is elastically deformed when a pressing force by the resilient member 76 acts between the contact surface 22b and the facing surface 74 due to the contact with the facing surface 74 of the lid member 72. In addition, in a case where the facing surface 74 includes the elastically deformable portion 84, the elastically deformable portion 84 is elastically deformed when the pressing force by the resilient member 76 acts between the contact surface 22b and the facing surface 74 due to the contact with the contact surface 22b. In the present embodiment, when the pressing force by the resilient member 76 acts between the contact surface 22b and the facing surface 74, the elastically deformable portion 84 is elastically deformed, so that a timing at which the lid member 72 comes into contact with the contact surface 22b is delayed. Thus, the timing at which the lid member 72 closes the opening 22a is delayed.

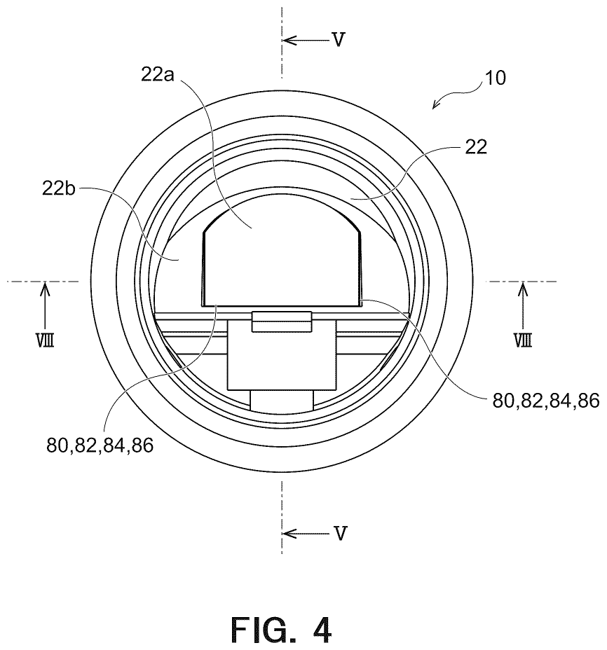

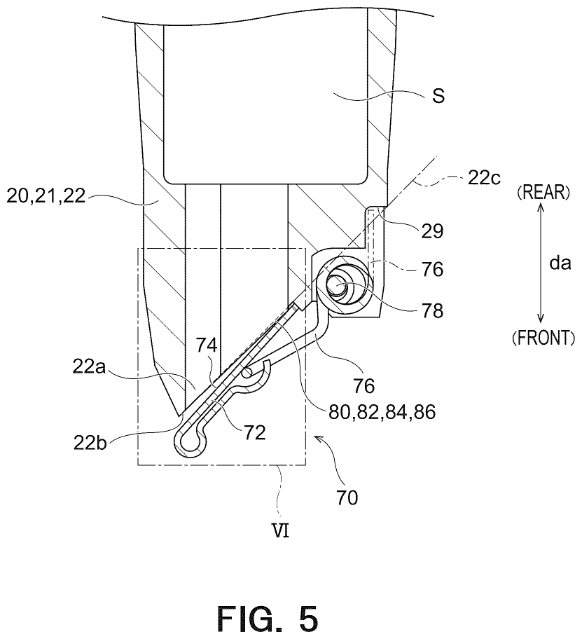

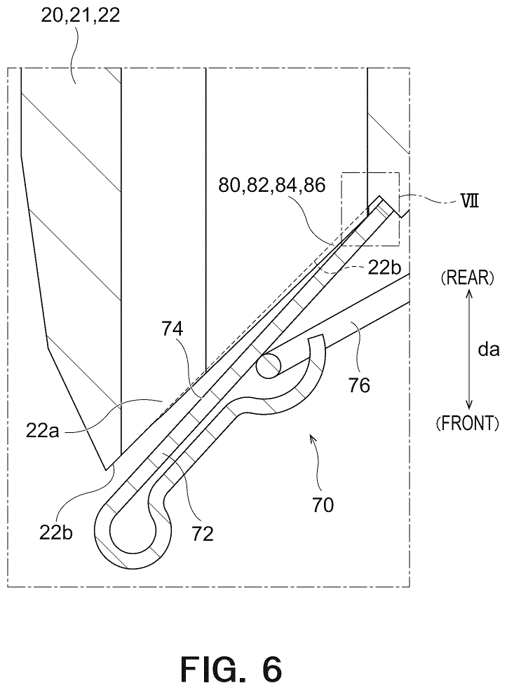

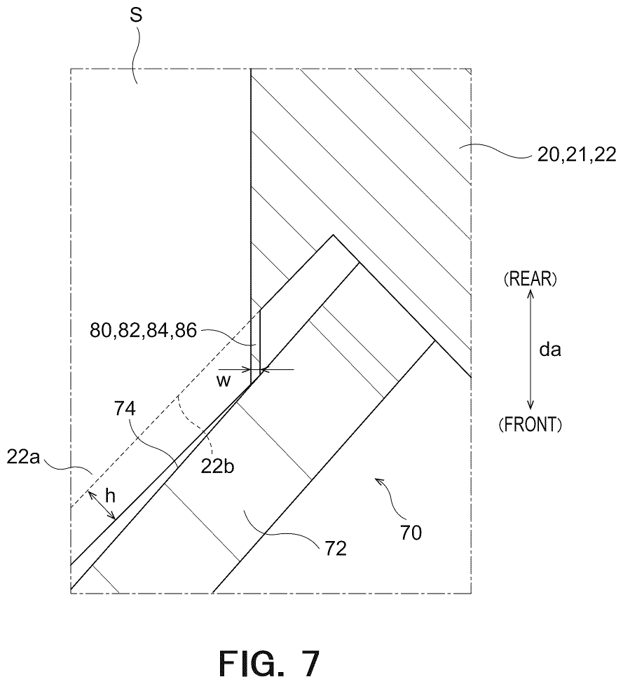

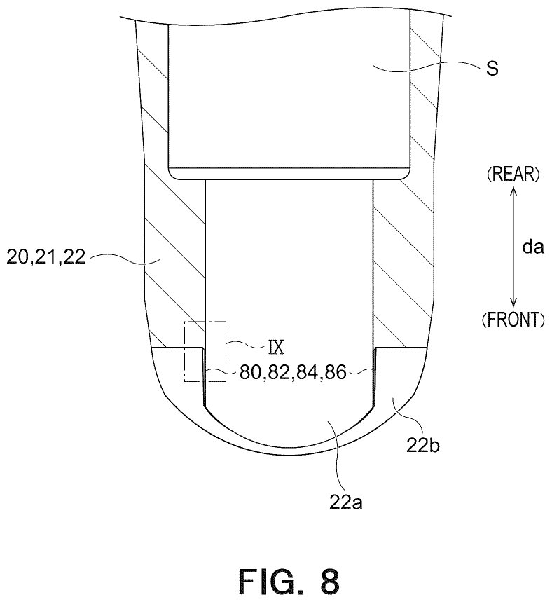

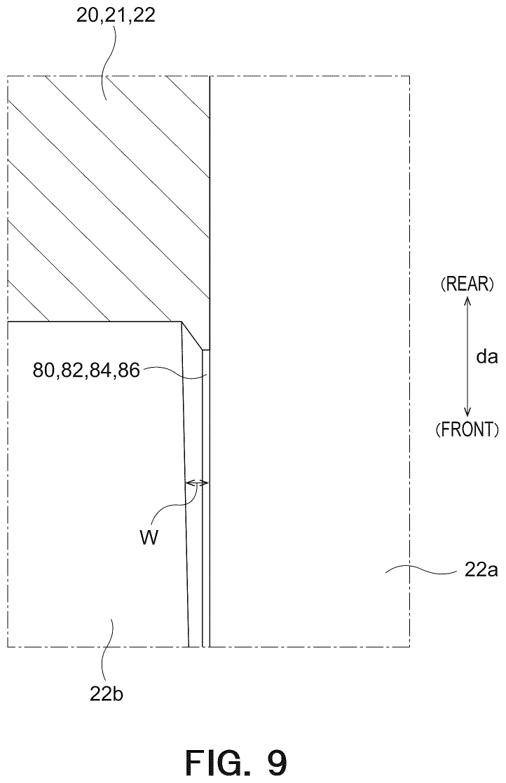

An example of the elastically deformable portion 84 will be described with reference to FIGS. 4 to 9. FIG. 4 is a view illustrating an example of the negative pressure suppression mechanism 80 when viewed from the front. FIG. 5 is a longitudinal sectional view illustrating an example of the negative pressure suppression mechanism 80, and particularly illustrates a cross section taken along line V-V in FIG. 4. FIG. 6 is an enlarged view of a part denoted by VI in FIG. 5. FIG. 7 is an enlarged view of a part denoted by VII in FIG. 6. FIG. 8 is a longitudinal sectional view illustrating a part of the negative pressure suppression mechanism 80, and particularly illustrates a cross section taken along line VIII-VIII in FIG. 4. FIG. 9 is an enlarged view of a part denoted by IX in FIG. 8.

The elastically deformable portion 84 may be a protrusion 86 protruding from the contact surface 22b of the barrel 20 (the inner barrel 22) or the facing surface 74 of the lid member 72. In the present embodiment, the elastically deformable portion 84 is the protrusion 86 protruding from the contact surface 22b. Note that the elastically deformable portion 84 is not limited thereto, and may be the protrusion 86 protruding from the facing surface 74.

The protrusion 86 at least partially surrounds the opening 22a. The protrusion 86 may surround only a part of the opening 22a or may surround the entire opening 22a. In the example illustrated in FIG. 4, the protrusion 86 is provided in a part of a side (lower side in FIG. 4) close to the rotational axis (the pin 78) of the lid member 72 around the opening 22a, and is not provided in a part of a side (upper side in FIG. 4) far from the rotational axis of the lid member 72 around the opening 22a.

As illustrated in FIGS. 5 to 7, a height h (see FIG. 7) of the protrusion 86 along a direction perpendicular to the contact surface 22b decreases as a distance from the rotational axis of the lid member 72 increases. A part of the lid member 72 close to the rotational axis receives a large pressing force from the lid member 72. Therefore, it is possible to effectively delay the timing at which the lid member 72 closes the opening 22a by increasing the height h of the protrusion 86 in the part close to the rotational axis of the lid member 72.

A width W of the protrusion 86 may be 0.01 mm or more and 1.0 mm or less. Preferably, the width W of the protrusion 86 may be 0.01 mm or more and 0.5 mm or less.

The rotational axis of the lid member 72 is located opposite to the housing space S with respect to an extended plane 22c of the contact surface 22b. In the example illustrated in FIG. 5, the rotational axis of the lid member 72 is located in front of the extended plane 22c of the contact surface 22b. In this case, it is possible to secure a sufficient wall thickness of the inner barrel 22 in a part at the rear (on the operation portion 52 side) of the rotational axis. Thus, it is possible to secure a sufficient size of the recess 29 for housing an end portion of the resilient member 76 while securing the strength of the inner barrel 22. Therefore, the strength of a front end portion of the inner barrel 22 can be improved, and the degree of freedom in designing the size, shape, and the like of the resilient member 76 can be improved. Thus, it is possible to effectively suppress the occurrence of deformation such as distortion in the inner barrel 22 due to the spring force of the resilient member 76 when the lid member 72 is opened and closed.

Note that a specific configuration of the closing delay mechanism 82 is not limited to the above-described configuration including the elastically deformable portion 84. The closing delay mechanism 82 may be any mechanism as long as it is possible delay the timing at which the lid member 72 closes the opening 22a of the barrel 20 (the inner barrel 22). The closing delay mechanism 82 may be, for example, a mechanism having a friction structure in which components come into contact with each other from the middle during the closing of the lid member 72 to generate a frictional force, and this frictional force delays the timing at which the lid member 72 closes the opening 22a. The closing delay mechanism 82 may be, for example, a mechanism having a damper structure other than the elastically deformable portion 84. Examples of the damper structure other than the elastically deformable portion 84 include a damper structure using a viscous body, air, or the like.

On the other hand, according to the closing delay mechanism 82 having the elastically deformable portion 84 in the present embodiment, it is possible to easily form the closing delay mechanism 82, and there are advantages that the stability in operation, the cost required for formation, the miniaturization and durability of the closing delay mechanism 82, and the like are excellent.

Next, an operation of the advancing and retracting mechanism 40 will be described with reference to FIGS. 1 and 2.

When the user presses the push member 50 forward in the retracted state (FIG. 1), the writing member 12 moves forward via the rotary cam member 60. When the writing member 12 moves forward, the pen tip 13 pushes the lid member 72 forward against the spring force of the resilient member 76 to open the lid member 72. When the writing member 12 further moves forward, the pen tip 13 protrudes forward from the front end opening 20a. Even when the forward pressing of the push member 50 is released, the writing member 12 maintains a state in which the pen tip 13 protrudes forward from the front end opening 20a. Thus, the writing instrument 10 transitions from the retracted state to the protruding state.

In addition, in the protruding state (FIG. 2), when the user presses the push member 50 forward, the writing member 12 moves forward by a minute distance. When the forward pressing of the push member 50 is released, the writing member 12 moves rearward by the spring force of the first resilient member 42, and the pen tip 13 is retracted from the front end opening 20a. When the writing member 12 further moves rearward, the pen tip 13 is housed in the housing space S, and the lid member 72 closes the opening 22a of the barrel 20 (the inner barrel 22) by the spring force of the resilient member 76. Thus, the housing space S is sealed. As the housing space S is sealed, drying of the ink at the pen tip 13 is suppressed in the retracted state.

Next, an operation of the sealing mechanism 70 will be described with reference to FIGS. 5 to 7 and FIGS. 10 to 12. FIGS. 5 and 10 to 12 illustrate the barrel 20 (the inner barrel 22), the lid member 72, the resilient member 76, the pin 78, and the negative pressure suppression mechanism 80 constituting the sealing mechanism 70 and do not illustrate the other members constituting the writing instrument 10.

When the writing member 12 moves rearward and the pen tip 13 is retracted into the housing space S at the time of transition from the protruding state to the retracted state, the lid member 72 is rotationally moved toward the contact surface 22b of the barrel 20 (the inner barrel 22) by the spring force of the resilient member 76. Thus, first, the facing surface 74 of the lid member 72 is brought into contact with a distal end of a part of the protrusion 86 disposed closest to the rotational axis (the pin 78) of the lid member 72 as illustrated in FIG. 5 to FIG. 7.

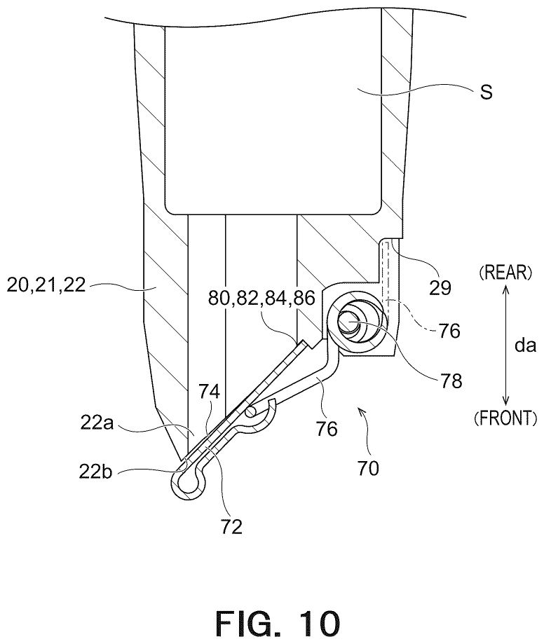

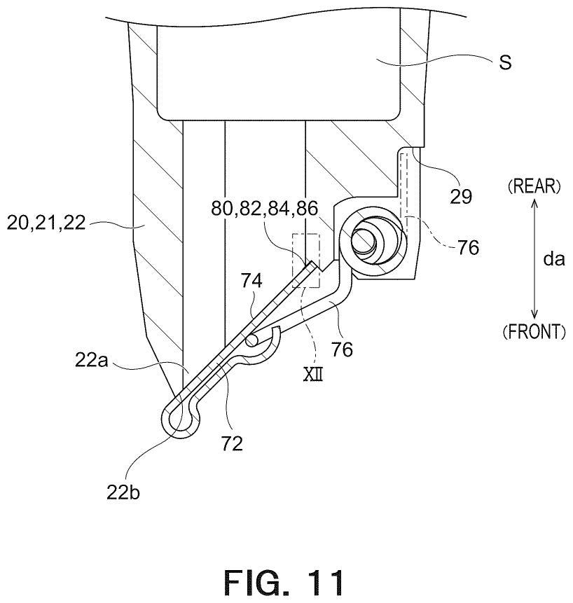

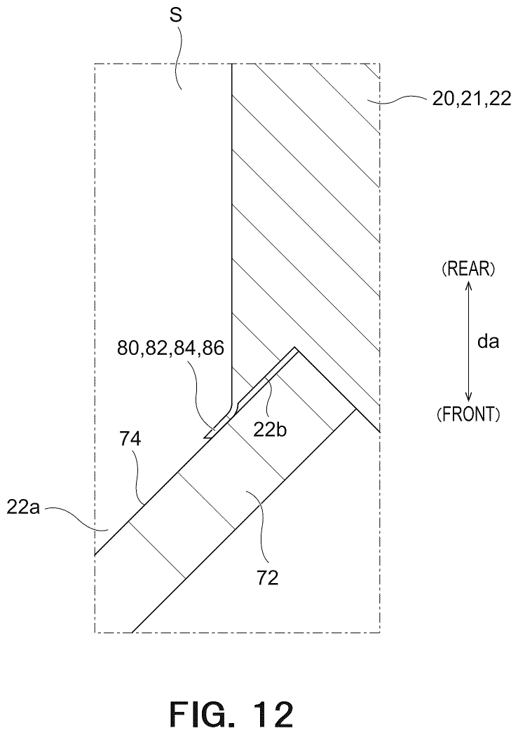

The protrusion 86 is configured to be elastically deformable by receiving the pressing force by the resilient member 76 via the lid member 72. When the protrusion 86 further receives the pressing force from the state illustrated in FIGS. 5 to 7, the protrusion 86 is elastically deformed so that and the facing surface 74 of the lid member 72 approaches the contact surface 22b as illustrated in FIG. 10. When the protrusion 86 further receives the pressing force from the state illustrated in FIG. 10, the protrusion 86 is further elastically deformed so that the facing surface 74 of the lid member 72 comes into contact with the contact surface 22b as illustrated in FIGS. 11 and 12. Thus, the lid member 72 closes the opening 22a. In the example illustrated in FIG. 12, the protrusion 86 is elastically deformed so as to fall down toward the inside of the opening 22a.

In the present embodiment, since the protrusion 86 is elastically deformed when the pressing force by the resilient member 76 acts between the contact surface 22b and the facing surface 74, the timing at which the lid member 72 comes into contact with the contact surface 22b can be delayed. Thus, the timing at which the lid member 72 closes the opening 22a can be The writing instrument 10 according to the present embodiment includes: the barrel 20 having the opening 22a; the writing member 12 having the pen tip 13; the advancing and retracting mechanism 40 that advances and retracts the pen tip 13 from the opening 22a; and the sealing mechanism 70 that seals the housing space S of the pen tip 13 in the retracted state of the pen tip 13, the sealing mechanism 70 having the lid member 72 capable of coming into contact with the contact surface 22b surrounding the opening 22a to close the opening 22a, and the negative pressure suppression mechanism 80 that suppresses the pressure in the housing space S from becoming the negative pressure.

According to such writing instrument 10, when the writing instrument 10 transitions from the protruding state illustrated in FIG. 2 to the retracted state illustrated in FIG. 1, it is possible to suppress the generation of the negative pressure inside the housing space S due to the rearward movement of the writing member 12 after the lid member 72 closes the opening 22a. Thus, it is possible to effectively suppress the ink housed inside the writing member 12 from leaking into the housing space S through the pen tip 13.

In the writing instrument 10 of the present embodiment, the negative pressure suppression mechanism 80 includes the closing delay mechanism 82 that delays the timing at which the lid member 72 closes the opening 22a.

According to the above writing instrument 10, the amount of rearward movement of the writing member 12 after the opening 22a is closed is reduced by delaying the timing at which the lid member 72 closes the opening 22a, whereby it is possible to suppress the pressure of the housing space S from becoming the negative pressure.

In the writing instrument 10 of the present embodiment, the lid member 72 has the facing surface 74 facing the contact surface 22b, and the closing delay mechanism 82 has the elastically deformable portion 84 provided on the contact surface 22b or the facing surface 74.

According to the writing instrument 10, since the elastically deformable portion 84 is elastically deformed when the pressing force by the resilient member 76 acts between the contact surface 22b and the facing surface 74, the timing at which the lid member 72 comes into contact with the contact surface 22b can be delayed. Thus, the timing at which the lid member 72 closes the opening 22a can be delayed.

In the writing instrument 10 of the present embodiment, the elastically deformable portion 84 is the protrusion 86 protruding from the contact surface 22b or the facing surface 74.

According to the writing instrument 10, the elastically deformable portion 84 can be formed with a simple structure.

In the writing instrument 10 of the present embodiment, the protrusion 86 at least partially surrounds the opening 22a.

According to the writing instrument 10, the protrusion 86 can be efficiently disposed between the contact surface 22b and the facing surface 74.

In the writing instrument 10 of the present embodiment, the height h of the protrusion 86 along the direction perpendicular to the contact surface 22b or the facing surface 74 decreases as the distance from the rotational axis of the lid member 72 increases.

According to the writing instrument 10, the timing at which the lid member 72 closes the opening 22a can be effectively delayed by increasing the height h of the protrusion 86 in the part close to the rotational axis (the pin 78) of the lid member 72.

In the writing instrument 10 of the present embodiment, the rotational axis of the lid member 72 is located opposite to the housing space S with respect to the extended plane 22c of the contact surface 22b.

According to the writing instrument 10, it is possible to secure a sufficient wall thickness of the inner barrel 22 in the part at the rear (on the operation portion 52 side) of the rotational axis. Thus, it is possible to secure a sufficient size of the recess 29 for housing an end portion of the end portion of the resilient member 76 while securing the strength of the inner barrel 22. Therefore, the strength of a front end portion of the inner barrel 22 can be improved, and the degree of freedom in designing the size, shape, and the like of the resilient member 76 can be improved. Thus, it is possible to effectively suppress the occurrence of deformation such as distortion in the inner barrel 22 due to the spring force of the resilient member 76 when the lid member 72 is opened and closed.

1. A writing instrument comprising: a barrel having an opening; a writing member having a pen tip; an advancing and retracting mechanism that advances and retracts the pen tip from the opening; and a sealing mechanism that seals a housing space of the pen tip in a retracted state of the pen tip, wherein
the sealing mechanism has
a lid member capable of coming into contact with a contact surface surrounding the opening to close the opening, and
a negative pressure suppression mechanism that suppresses a pressure in the housing space from becoming a negative pressure.

2. The writing instrument according to claim 1, wherein the negative pressure suppression mechanism has a closing delay mechanism that delays a timing at which the lid member closes the opening.

3. The writing instrument according to claim 2, wherein
the lid member has a facing surface facing the contact surface, and
the closing delay mechanism has an elastically deformable portion provided on the contact surface or the facing surface.

4. The writing instrument according to claim 3, wherein the elastically deformable portion is a protrusion protruding from the contact surface or the facing surface.

5. The writing instrument according to claim 4, wherein the protrusion at least partially surrounds the opening.

6. The writing instrument according to claim 4, wherein a height of the protrusion along a direction perpendicular to the contact surface or the facing surface decreases as a distance from a rotational axis of the lid member increases.

7. The writing instrument according to claim 1, wherein a rotational axis of the lid member is located opposite to the housing space with respect to an extended plane of the contact surface.
